(19) United States
(12) Patent Application Publication
(10) Pub. No.: US 2010/0085166 A1
(43) Pub. Date: Apr. 8, 2010

(54) METHOD FOR THE PRODUCTION OF A TEXTILE LABEL HAVING AN RFID TRANSPONDER CHIP AND INTERLACED INFORMATION CARRIER, AND SYSTEM FOR CARRYING OUT THE METHOD

(76) Inventor: Francisco Speich, Gipf-Oberfrick (CH)

Correspondence Address: GEORGE PAPPAS;HARRISON PLACE SUITE 300, 919 S. HARRISON STREET, FORT WAYNE, IN, 46802, US

(21) Appl. No.: 12/449,360

(22) PCT Filed: Feb. 11, 2008
(86) PCT No.: PCT/CH2008/000049

§ 371 Date: Aug. 4, 2009

(30) Foreign Application Priority Data
Feb. 12, 2007 (CH) 230/07

(51) Int. Cl. H04Q 5/22

(52) U.S. Cl. 340/10.51

(57) ABSTRACT

In order to configure a textile label having an RFID transponder comprising information, particularly comprising individual pieces of information that may differ from label to label, so that it is more operationally safe, the invention provides that the label has interlaced information. For this purpose, the information present in the RFID transponder can be calculated by means of a fixed algorithm from the interlaced information. The label is first produced with the interlaced information, the interlaced information is then read, and the RFID transponder is then programmed with information, and the information from the two sources is advantageously compared again in a subsequent step.

This application claims priority of PCT application PCT/CH2008/000049 having a priority date of Feb. 12, 2007, the disclosure of which is incorporated herein by reference.

### TECHNICAL FIELD

The invention relates to a method for producing a textile tag having an RFID transponder chip and to an installation for carrying out the method.

### BACKGROUND OF THE INVENTION

By way of example, US 2003/0160732, WO 2005/071605 and EP-A-0 822 527 disclose the practice of providing textile tags with RFID transponders. In this case, the RFID transponders are used predominantly for the automatic reading of identification numbers and specifications for the product on which they are sewn, which are usually held in a database and which allow the number to be associated with the type of goods, etc. to which the tag is connected. The automatic reading does not require visual contact. The reading distance for such RFID transponders may be up to 10 m or more. However, it has been found to be a problem that transponders may be faulty, whether as a result of improper handling, for example when washing, or as a result of a fracture on account of wear.

In addition, EP-A-0 919 650, U.S. Pat. No. 4,766,301 A, WO-A-00/73559 and WO-A-03/000974, for example, disclose tags which have bar codes applied (e.g. printed on) or woven in. Such bar codes on the tags are also used predominantly for the automatic reading of identification numbers, which are likewise held in a database and which allow the number to be associated with the type of goods etc. to which the tag is connected. The automatic reading requires visual contact. The reading distance for such bar codes is usually approximately 15 cm. In the case of tags with a bar code, a cell code or a two-dimensional code, it has been found to be a problem that these become soiled and then the information can no longer be read. WO 00/16254 A1 discloses a textile tag which contains printed or woven-in care information which is additionally held in an electronic transponder “applied” to the tag. Although WO 00/16254 A1 describes this tag, it does not deal with the production and the associated problems, particularly when weaving in the information. In this case, the following problem, which cannot be solved particularly by WO 00/16254 A1, should be pointed out: whereas care tags do not differ for a large number of individual items, and hence there is barely any occurrence of logistical problems relating to the association of respective unitary tags—that is to say tags with a respective individual code portion—the present invention needs to deal with this problem first of all. Similar subject matter to that in WO 00/16254 A1 is also known from WO 03/065303 A1, without the remaining problems being dealt with therein.

EP-A-1 538 552 discloses a printing system which allows a reliable production system for printing information onto a medium which also has an electronic transponder. The specific problems in producing a textile tag in which the information is woven in have no attempt at a solution made by EP-A-1 538 552, however.

### SUMMARY OF THE INVENTION

The object of the invention is to provide a method for producing a textile tag having an RFID transponder and a piece of woven-in information—particularly a tag which differs from the other tags in the production process in at least one code portion—in which the problems associated with production, particularly during weaving-in of the information and the subsequent harmonization with the information programmed in the RFID chip, can be avoided. In particular, the aim is to avoid losses of information of the type described above.

In this case, the first result of the measures in the invention is that the combination according to the invention allows losses of information to be prevented and allows safer harmonization of the woven-in information and of the information programmed in the RFID chip. In particular, textile tags with a faulty transponder or faulty transponder readers allow the information to be read via the bar code or the alphanumeric encoding features. Secondly, if the bar code is soiled or has been rendered illegible or partly illegible in another way, it is possible to use the information from the transponder chip. It should be pointed out that the invention is not intended to be limited to information which is applied or included as a bar code, but also covers information presented in another way, e.g. presented text or numbers. In addition, this information may be readable not only in the visible range but also in the UV range or in the infrared range, for example.

In addition, the object of the invention is achieved by an installation.

Depending on the embodiment of the RFID transponder, it may be advantageous if the information in the RFID transponder is programmed in non-erasably, partially erasably or in overwritable form.

In principle, the method makes provision for the RFID chip to be programmed after the code is woven in. For particular applications, it is advantageous in this context if the RFID transponder is mounted on the tag after its information has been programmed in. This means an at least partially parallel production method which concludes with a finished tag as soon as the RFID transponder chip has been mounted. The advantage in this case is simple configuration control. For particular production methods, however, it may also be advantageous if the RFID transponder is mounted on the tag first of all and is then programmed, if this results in increased flexibility for the production process.

The advantages of the method according to the invention become particularly important when or as a result of the fact that after the information has been woven in, has been read and the same information, or information ascertained on the basis of an associated algorithm, has been programmed into the transponder chip—before or after the transponder chip is mounted on the tag—the information on the transponder chip is again compared with the woven-in information—with or without renewed reading of the woven-in information.

The aforementioned elements and those claimed and described in the exemplary embodiments which follow, and which are to be used in line with the invention, are not subject to any particular exceptional conditions in terms of their size, design, material use and their technical concept, which means that the selection criteria known in the respective field of application can be used unrestrictively.

### BRIEF DESCRIPTION OF THE DRAWINGS

Exemplary embodiments of the invention are described in more detail below with reference to the drawings, in which:

FIG. 1 shows a typical tag based on a preferred exemplary embodiment of the present invention, in which a bar code has been woven into one half of the tag, while the other half of the tag has a transponder chip mounted on it between two meandrously arranged antenna portions;

FIG. 2 shows a plan view of a typical visible bar code on a tag;

FIG. 3 shows a side view of the tag shown in FIG. 3;

FIG. 4 shows a typical invisible bar code which is arranged over a legible tag portion with text; and

FIG. 5 shows a block diagram of an installation for carrying out the method according to the invention with the method steps.

### DETAILED DESCRIPTION OF THE PREFERRED EMBODIMENTS

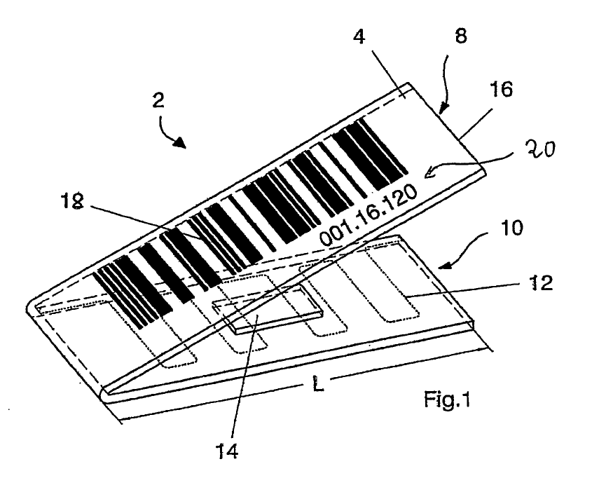

FIG. 1 shows a typical tag 2 based on a preferred exemplary embodiment of the present invention. In this case, the textile tag has an RFID transponder 14 which contains information.

In addition, the tag has woven-in information 18. In the exemplary embodiment, the information contained in the RFID transponder 14 can be calculated by a fixed algorithm from the woven-in information 18. In the present exemplary embodiment, however, the woven-in information 18 can also be calculated by a fixed algorithm from the information contained in the RFID transponder 14. This is because the information contained in the RFID transponder 14 and the woven-in information 18 are identical codes. This makes implementation of the information particularly simple.

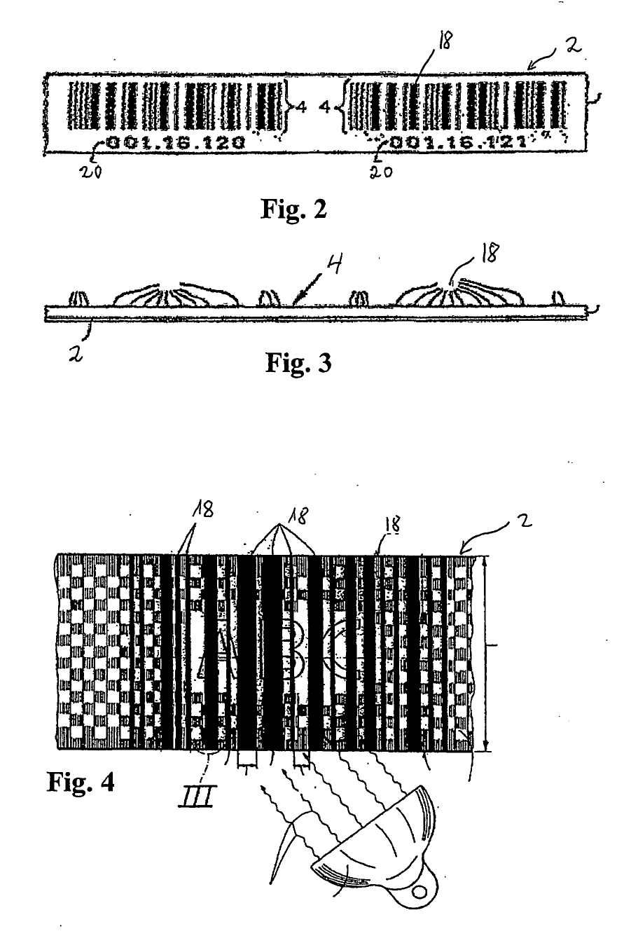

In the present exemplary embodiment, the woven-in information 18 is arranged on the upper portion 8 of a folded tag 2 on a face 4 provided for this purpose. In the present exemplary embodiment, the woven-in information 18 can be sensed optically. In addition to the bar code, cell code or two-dimensional code, the information or portions thereof is also woven in as legible digits 20 or as writing, as shown in FIGS. 2 and 3.

In this case, “optically” does not necessarily have to mean that the information is legible in the visible wavelength range. An alternative possibility, as provided in FIG. 4, is instead also optical reading areas, particularly in the UV range. This invisible, woven-in bar code 22 is covered or underlaid in the visible range by a likewise woven-in application.

The data in the RFID transponder 14 are programmed in partiably erasably and in overwritable form. While a particular manufacturer area of the RFID transponder 14, which indicates the transponder manufacturer, and a manufacturer area which indicates the tag manufacturer are programmed in permanently, that is to say so as to be neither erasable nor overwritable, another data area is erasable and rewritable, in principle. This is advantageous for logistical reasons.

In one preferred embodiment for producing the tag 2 as described above, the tag 2 is first of all produced with the woven-in information 18, in the present exemplary embodiment woven on a weaving machine 100 in the first step 30. The woven-in information 18 is then read by means of a reading device, which is associated with the chip module composing machine 200, in step 32, in the present exemplary embodiment is optically scanned, and then the RFID transponder 14 is programmed with information in step 34, said information being calculated using an algorithm from the read information. In this case, the RFID transponder 14 can be mounted on the tag 2 after its information has been programmed in, this allowing a fast, parallel production method. The RFID transponder 14 is mounted on the lower portion 10 of the tag 2 based on the preferred exemplary embodiment of the present invention between two meandrously arranged antenna portions 12. To lengthen the antenna, the antenna 12 may be continued on the upper tag portion 8 in the exemplary embodiment shown in FIG. 1.

In one preferred exemplary embodiment for producing a tag, the basic operation described above is followed by the data being read from the transponder again and compared with the optically readable, woven-in information—with or without a renewed optical reading operation for this woven-in information—in step 36. If the measure decision 38 has indicated no problems, the tag is cut 40 and if necessary folded, otherwise the tag is cut and discarded 42. To increase quality, the result of the comparison is detected—in the present exemplary embodiment statistically—and reported back 50 in order to take measures to increase quality if necessary.

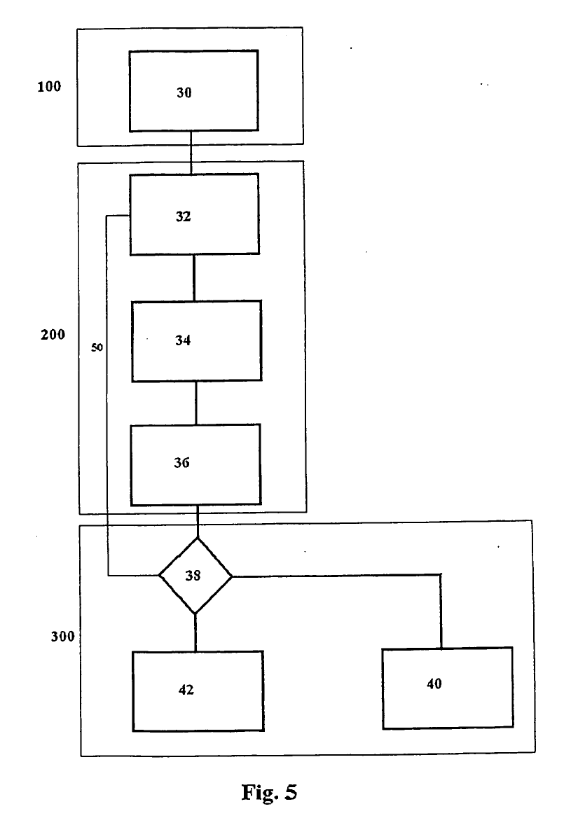

To carry out the method according to the invention, an installation (FIG. 5) is used which comprises a weaving machine 100, preferably a ribbon weaving machine. In addition, the installation has a chip module composing machine 200 with a supply device for supplying the RFID transponder chips and also a reading device for reading—in the present exemplary embodiment optically—the woven-in information. This reading device therefore has two functions, namely quality assurance—ensuring that the woven-in information can be read—and also harmonization of the information on the RFID transponder with the woven-in information. In addition, the installation has a programming device for programming information into the RFID transponder chip and a control and computation device. In the control and computation device, the optical information which is read is converted by means of a fixed algorithm into a code which is programmed into the RFID transponder chip. In the simplest case, such an algorithm may be a direct reversible association of the information.

To allow an even higher degree of quality assurance, the installation in the present exemplary embodiment also has a device which can be used to read the information from the RFID transponder chip and to compare it with the woven-in information again, with the opportunity to read the woven-in information optically again for this purpose. In addition, the installation has a cutting and folding machine 300 in which the tags are cut and, if necessary, folded or discarded 40, 42.

### LIST OF REFERENCE SYMBOLS

2 Tag
4 Face for bar code
8 Upper tag portion
10 Lower tag portion
12 Antenna
14 Transponder chip
16 Edge
18 Bar code, line code or two-dimensional code
20 Digits or writing
30 Weaving
32 Sensing the woven-in information
34 Programming the sensed information into the RFID chip
36 Checking for the match
38 Measured decision
40 Cutting the tags and folding
42 Cutting and discarding
50 Reporting to increase quality
100 Weaving machine
200 Chip module composing machine
300 Cutting and folding machine

1. A method for producing a textile tag having an information-containing RFID transponder and woven-in information, namely a bar code, wherein the information contained in the RFID transponder can be calculated by a fixed algorithm from the woven-in information, characterized in that
the bar code on a tag differs in at least one code portion from the bar code on the other tags in the production process,
the tag with the woven-in bar code is produced first of all, and then the woven-in information is read, preferably optically scanned, and
then the RFID transponder is programmed with information which is calculated using an algorithm from the read information.

2. The method as claimed in claim 1, characterized in that the information in the RFID transponder is programmed in non-erasably, partially erasably or in overwritable form.

3. The method as claimed in claim 1, characterized in that the RFID transponder is mounted on the tag after its information has been programmed in.

4. The method as claimed in claim 1, characterized in that the RFID transponder is mounted on the tag first of all and is then programmed.

5. The method as claimed in claim 1, characterized in that the information programmed into the RFID transponder is then read and compared with the woven-in bar code—with or without renewed optical reading of the woven-in information.

6. An installation for producing a textile tag having an information-containing RFID transponder and woven-in information, namely a bar code, having a weaving machine for weaving the tag and the woven-in bar code, particularly as claimed in claim 1, having a reading device for reading the woven-in bar code and a programming device for programming bar code into the RFID transponder, characterized by a control and computation device for controlling the weaving operation for the tag and also for controlling the reading of the woven-in bar code, and also for calculating the information to be programmed in the RFID transponder using a fixed algorithm from the woven-in bar code and for controlling the programming device.

7. The installation as claimed in claim 6, also characterized by a device for mounting the RFID transponder before or after its information is programmed in on the tag.

8. The installation as claimed in claim 5, characterized in that the control and computation device comprises means for reading the information programmed into the RFID transponder and also means for comparing the information programmed into the RFID transponder with the woven-in bar code.

9. The method as claimed in claim 2, characterized in that the RFID transponder is mounted on the tag after its information has been programmed in.

10. The method as claimed in claim 2, characterized in that the RFID transponder is mounted on the tag first of all and is then programmed.

11. The method as claimed in claim 2, characterized in that the information programmed into the RFID transponder is then read and compared with the woven-in bar code—with or without renewed optical reading of the woven-in information.

12. The method as claimed in claim 3, characterized in that the information programmed into the RFID transponder is then read and compared with the woven-in bar code—with or without renewed optical reading of the woven-in information.

13. The method as claimed in claim 4, characterized in that the information programmed into the RFID transponder is then read and compared with the woven-in bar code—with or without renewed optical reading of the woven-in information.

14. An installation for producing a textile tag having an information-containing RFID transponder and woven-in information, namely a bar code, having a weaving machine for weaving the tag and the woven-in bar code, particularly as claimed in claim 2, having a reading device for reading the woven-in bar code and a programming device for programming bar code into the RFID transponder, characterized by a control and computation device for controlling the weaving operation for the tag and also for controlling the reading of the woven-in bar code, and also for calculating the information to be programmed in the RFID transponder using a fixed algorithm from the woven-in bar code and for controlling the programming device.

15. An installation for producing a textile tag having an information-containing RFID transponder and woven-in information, namely a bar code, having a weaving machine for weaving the tag and the woven-in bar code, particularly as claimed in claim 3, having a reading device for reading the woven-in bar code and a programming device for programming bar code into the RFID transponder, characterized by a control and computation device for controlling the weaving operation for the tag and also for controlling the reading of the woven-in bar code, and also for calculating the information to be programmed in the RFID transponder using a fixed algorithm from the woven-in bar code and for controlling the programming device.

16. An installation for producing a textile tag having an information-containing RFID transponder and woven-in information, namely a bar code, having a weaving machine for weaving the tag and the woven-in bar code, particularly as claimed in claim 4, having a reading device for reading the woven-in bar code and a programming device for programming bar code into the RFID transponder, characterized by a control and computation device for controlling the weaving operation for the tag and also for controlling the reading of the woven-in bar code, and also for calculating the information to be programmed in the RFID transponder using a fixed algorithm from the woven-in bar code and for controlling the programming device.

17. An installation for producing a textile tag having an information-containing RFID transponder and woven-in information, namely a bar code, having a weaving machine for weaving the tag and the woven-in bar code, particularly as claimed in claim 5, having a reading device for reading the woven-in bar code and a programming device for programming bar code into the RFID transponder, characterized by a control and computation device for controlling the weaving operation for the tag and also for controlling the reading of the woven-in bar code, and also for calculating the information to be programmed in the RFID transponder using a fixed algorithm from the woven-in bar code and for controlling the programming device.

18. The installation as claimed in claim 6, characterized in that the control and computation device comprises means for reading the information programmed into the RFID transponder and also means for comparing the information programmed into the RFID transponder with the woven-in bar code.
